(19) United States
(12) Patent Application Publication
(10) Pub. No.: US 2024/0057562 A1
(43) Pub. Date: Feb. 22, 2024

(54) Flea & Tick Preventing Clip for Dogs

(71) Applicant: Seungmin Bang, Los Angeles, CA (US)

(72) Inventor: Seungmin Bang, Los Angeles, CA (US)

(21) Appl. No.: 17/892,129

(22) Filed: Aug. 22, 2022

(51) Int. Cl. A01K 27/00

(52) U.S. Cl. CPC A01K 27/007

(57) ABSTRACT

The present invention relates to an advancement in a Flea & Tick Preventing Clip which can be attached/dethatched easily from dog collar and provides enhanced protection to the pet. The assembly is high quality, easy to use and sustainable in nature.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention pertains to animal collars and harnesses and more particularly to a clip design which can be attached to collars or harness to disperses a chemical to rid the animal of fleas and ticks.

### Description of the Related Art

The conventional animal flea collar consists of a chemically impregnated plastic strap which is tied about the animal's neck. The plastic allows the chemical to slowly escape thereby ridding the animal of fleas for a period of time. However, when the chemical is exhausted the collar is no longer effective and therefore must be discarded and replaced with a new collar. Such collars are generally effective for a period of from one to three months. See U.S. Pat. No. 3,918,407 to Greenberg for a description of this type of pet collar. This type of collar does not have sufficient strength to serve as a restraining collar or to carry necessary license and vaccination tags, therefore, many animals, especially dogs, must wear both restraining collars and flea control collars.

A second type of flea retardant device is the flea tag. In this device, the flea retardant chemical is carried in a plastic tag which is attached to the animal's collar. The chemical is dispersed by the tag in a method similar to that of the collar. This device is generally less effective than the collar since its area of contact with the animal is limited. And, like the collar, the tag must be replaced when the chemical is exhausted.

The inherent disadvantage of the aforementioned prior art is that these devices provide various features however their ease of use for the dogs is questionable. Wearing them for longer period of time cause irritability and anger in the pets and their functionality is limited. Therefore, despite the availability of numerous providing functionalities in their own domain, there is still a need for a device that provides the consistent necessary functionality with ease of use and enhanced adaptability for dogs.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of pet. Moreover, the ease-of-use ability of these assemblies is also questionable. The current invention proposes an advance structure of dog collar attachment which is in form of clip and can be easily attached or detached. The clip has liquid embedded inside the clips which allow continuous distribution over dog's skin.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior dogs clips and provide an enhanced system to perform the designated functionality.

Another object of the present invention is to provide collar attachment which has clip with it for ease in attachment to dog's collar or harness.

It is a further objective of the present invention to provide an improved structure made of high quality materials including but not limited to hard plastic, or other synthetic material which maintain their effectiveness over longer period of time.

It is also the objective of invention to provide attachment which diffuses the scent from the middle pouch to provide proper protection to overall body of dog.

Thus, it is the objective to provide a new and improved form of an dog Flea & Tick Preventing Clip for Dogs. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWING

non-limiting and non-exhaustive embodiments of the present invention are described with reference to the following drawings. The system and method of the present invention will now be described with reference to the accompanying flow chart drawing figure, in which:

FIG. 1 shows the complete view of assembly as per preferred embodiments of the invention.

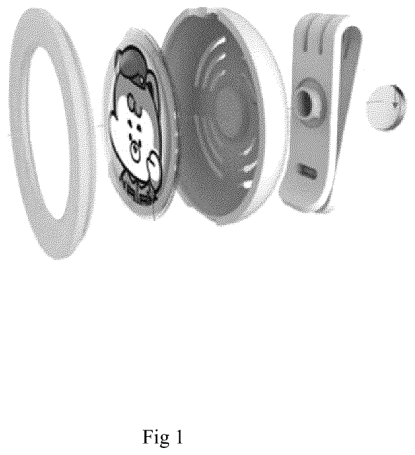

FIG. 2 shows multiple view of assembly as per preferred embodiments of the invention.

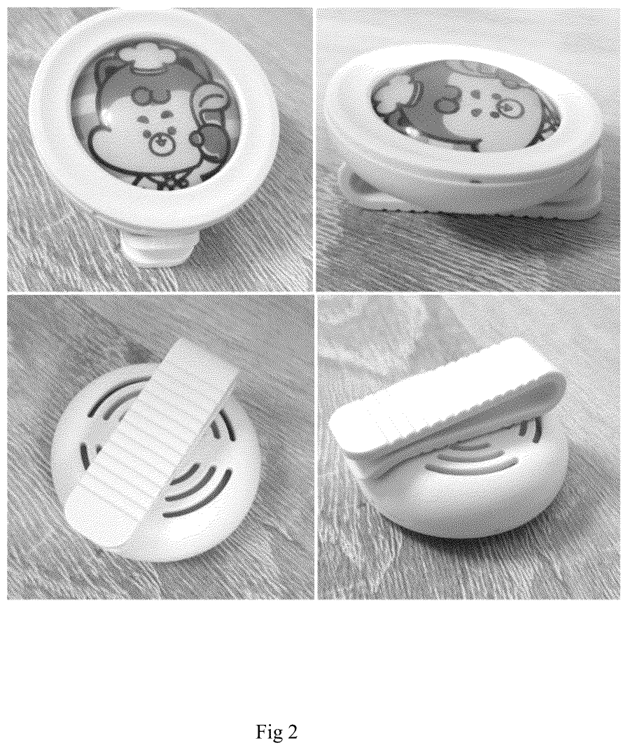

FIG. 3 shows the perspective use as per preferred embodiments of the invention.

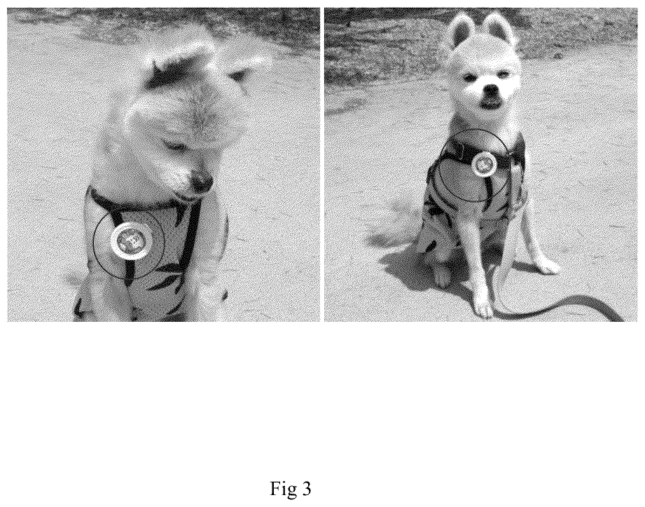

Skilled artisans will appreciate that elements in the figures are illustrated for simplicity and clarity and have not necessarily been drawn to scale. For example, the dimensions of some of the features in the figures may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The problems caused by fleas and ticks present on household pets have long been recognized. The insects not only irritate the animals but can be transferred to persons living in the vicinity of the animals. The ticks and fleas can also carry diseases which are transmittable to humans. In response to these problems, methods have been developed for ridding household pets of such insects. The methods include dipping the animal in an insecticide solution, dusting flea powder onto the animal, and the most common present method, the chemically-impregnated plastic flea collar.

Although the above methods have varying degrees of success, each has certain drawbacks to its use. The dipping method is inconvenient as well as expensive since it is usually carried out in a veterinarian's office. Dusting with flea powder is hazardous both to the pet and to the owner since it is difficult to control the exact amount that should be applied. The plastic flea collar is generally effective, but it has only a short lifetime, from one to three months, and at the end of this time it must be replaced. The periodic replacement of the flea collar presents a substantial expense to pet ownership. The plastic collar does not have sufficient strength for use as a restraining collar, therefore, it must be used in conjunction with a conventional collar. Thus, pets are often required to wear two collars simultaneously.

In accordance with the present invention there is provided an advance structure of Flea & Tick Preventing Clip for Dogs.

The Flea & Tick Preventing Clip for Dogs has an outer side that is placed against the harness or the collar of dog and is fastened with a clip-on inner side, where the outer side is the opposing side of the dog collar that is facing outwardly from the animal. The center of clip has a printed cover with pouch of liquid inside. The exposed area from the top case which exposes the scent to diffuse evenly across the body of pet.

The assembly's case is developed from high quality plastic which maintains its use and effectiveness over longer period of time.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: An insect control clip attachment for an animal wherein the assembly has a chemical which is slowly dispersed to repel or kill insects on the animal, comprising in combination;
As per claim 1, a flexible high-quality material made of hard plastic or other synthetic material;
As per claim 1, means for releasably securing the ends of said clip body to said collar body on the neck of the animal;
As per claim 1, wherein chemically-impregnated member is inform of pouch; and,
As per claim 1, a hinge to open and close in order to insert, remove, and secure the pouch containing liquid;
